(19) United States
(12) Patent Application Publication
(10) Pub. No.: US 2009/0037160 A1
(43) Pub. Date: Feb. 5, 2009

(54) METHOD AND APPARATUS TO SERVE IBIS DATA

(76) Inventor: Christopher W. Dix, Hillsboro, OR (US)

Correspondence Address: LATTICE SEMICONDUCTOR CORPORATION, 5555 NE MOORE COURT, HILLSBORO, OR, 97124-6421, US

(21) Appl. No.: 11/831,876

(22) Filed: Jul. 31, 2007

(51) Int. Cl. G06F 17/50

(52) U.S. Cl. 703/14

(57) ABSTRACT

In accordance with an embodiment of the present invention, a method of serving IBIS data may include determining a circuit specified for signal integrity simulation. IBIS data may be obtained for the circuit specified, from which polynomials may be determined to be representative of at least a portion of the IBIS data. The polynomial information determined may be stored in a file with indexing for enabling its subsequent selective retrieval by way of a request for the IBIS data for the specified circuit.

### TECHNICAL FIELD

The present disclosure is related to signal integrity analysis and more particularly to methods of and systems for serving Input/Output Buffer Information Specification (IBIS) data.

### BACKGROUND

Known IBIS standards generally set forth particular data formats for various Input/Output (I/O) buffer characteristics. The standards specify data formatting of known IBIS tabular data structures. With these well defined formats, it may then be parsed and utilized by end users within various design stations, such as Electronic Design Automation (EDA) platforms. Accordingly, the components within a proposed system design may then be evaluated by way of the IBIS data using known high level signal integrity analysis techniques.

For those skilled in the art, the IBIS data formats may be referenced as a cataloging of various characteristic curves and waveforms as a way of recording the properties of components, buffers and/or modules. Circuit designers may use the IBIS data to assist them in performing simulation verification of the particular component within a higher level signal integrity analysis procedure.

For example, a given component manufacture, developer or module vendor may develop a proprietary circuit model for a component that is to be made available to system integrators. The circuit developer may thus characterize the cataloged component of a proprietary structure using the various characteristic curves of the IBIS data standard. This may be recognized as enabling end users an ability to work with and understand the properties and integration needs to the various cataloged components in most any integration settings, e.g., EDA platforms. At the same time, the circuit developer may be able to preserve the propriety structure of the cataloged component.

It may be understood that EDA platform providers may also track IBIS standards and the IBIS data for the components of particular vendors. By monitoring the IBIS standards and data, EDA system providers may thus be able to more readily equip “end users”—i.e., such as integration engineers or system designers—with convenient simulation or analysis capability when working with the components cataloged by a given vendor.

To assist understanding of the IBIS type curves, referencing FIG. 5, the output 552 of buffer 551 may he characterized behaviorally using a variety of known characteristic curves. For example, a known type of voltage-current curve may be obtained for characterizing the output of the buffer when it is in a logic low state—i.e., “pull-down” curve. Another known type of voltage-current curve may be obtained for characterizing the output of the buffer when it is in a logic high state—i.e., “pull-up” curve. Additional typical types of curves may also be obtained for characterizing the voltage-current properties for the output of the buffer when subjected to bias levels beyond its lower supply; or similarly above the upper supply—i.e., “ground-clamp” and “power-clamp” curves respectively.

Further more, additional curves or waveforms may be obtained for characterizing the responsiveness of the buffer. For example, these may include the voltage versus time waveforms for each of “rising” and “falling” waveforms. The rising waveform may be understood to characterize the performance of the buffer when driving its output from a low level to a high level. The falling waveform, on the other hand, may be understood to characterize the performance of the buffer when driving the output from a high level to a low level.

Typically, the IBIS data associated with a given component may be identified by keywords and parameters by which the data may be tabulated. The tabulated data may then be referenced or selectively retrieved by way of specified keywords and/or parameters. The identifying information by which to selectively index or retrieve a given tabulation of IBIS data may include, for example, version of IBIS standard, file name, and file revisions, along with the component name and manufacture. Additional information for the keywords may include, for example, information of a packaging type, output-to-pin lead/bond-outs, or the particular mappings of pins-to-buffers. It may also be understood that the IBIS data could be further particularized to a variety of different designs for the buffer, even within a single component to a given vender.

The amount of IBIS data that may be needed for enabling analysis of a plurality of I/O buffers within the given component could be nominal in the case of common buffer usage. Alternatively, a particular application may require several different sets of IBIS data for each of a plurality of unique buffers applications within a more complicated system. Each unique buffer for the component, in turn, may require its own set of characteristic curves of, e.g., the pull-up, pull-down, ground-clamp, power-clamp, rising and failing waveforms.

In addition, it may be understood that each set of IBIS data may require further sub-sets as may be designated for various circuit conditions. Such conditions could include, for example, the impedance environments for the input and/or output interface for the buffer. Another condition for the buffer may include a fabrication tolerance of the vender, which may be associated with slow, typical or fast processing and various operational speeds. Further, a level of the supply voltage(s) may also be designated.

Accordingly, the amount of IBIS data that may be required by end users to enable high level signal integrity analysis of various cataloged components may become quite voluminous. In the case of certain types of programmable devices, e.g., Programmable Logic Devices, the need for accommodating a large number of different programmable resources of various configurations may be understood to further multiply the amount of required IBIS data.

Typical management of such large amounts of IBIS data may thus generally demand vast amounts of memory, lengthy lookup procedures, and/or bulky transfer processes as may be associated with the typical cataloging, storage, or serving of IBIS data.

### SUMMARY

In accordance with an embodiment of the present invention, a method of serving IBIS data may include determining a circuit specified for signal integrity simulation. IBIS data may be obtained for the circuit specified, from which polynomials may be determined to be representative of at least a portion of the IBIS data. The polynomial information determined may then be stored in a file with indexing for enabling selective retrieval by way of a request for the IBIS data for the specified circuit.

In a further embodiment, the IBIS data obtained may be defined by at least one of the characteristic IBIS curves of the group consisting of the pull-up, pull-down, ground-clamp, power-clamp, rising waveform or falling waveform types. The IBIS data may be yet further characterized relative to one of a variety of conditions for the specified circuit. Such conditions may comprise impedance, fabrication process tolerance as may be associated with slow or fast performance, a specified operational speed, and/or level of supply voltage. The file stored may thus be further indexed to enable its selective retrieval by way of such additional identifying information.

In another embodiment, a system to assist delivery of IBIS data may include a database having a plurality of selectively retrievable files. At least one of the selective files of the plurality may be preconfigured to store information for at least one polynomial predetermined to characterize at least a portion of the IBIS data to a given circuit. A controller of the system may be responsive to a request of a user to index the database for a select file, dependent upon the circuit specified in the user request. Information for at least one polynomial associated with a portion of the IBIS data to the given circuit as stored in the database may then be retrieved. This information retrieved may be sent to the user or given module of the user's design station.

In a further embodiment, the server station may further include a macro that may also be sent out to the user. The macro may be predefined to enable the user to parse the file delivered for information of the polynomial. Based upon the polynomial determined, IBIS data for the select circuit may then be recalculated for repopulating IBIS data of the standard IBIS format.

### BRIEF DESCRIPTION OF DRAWINGS

Subject matter for embodiments of the present invention may be further understood by reference to the following detailed description when read with reference to the accompanying drawings, in which:

FIG. 1A is a simplified block diagram of a system for serving IBIS data in accordance with an embodiment of the invention, and also showing the system as it might be employed with a given user station.

FIG. 1B is a simplified block diagram showing an example of a simulator as may be used for generation of IBIS data for certain embodiments of the present invention.

FIG. 2 is a simplified high level diagram of a network structure that may be associated with requesting IBIS data from a server station in accordance with an embodiment of the present invention.

FIG. 3A is an exemplary curve (or waveform) characteristic of given IBIS data and showing associated polynomial extractions that may be determined thereof in accordance with an embodiment of the present invention.

FIG. 3B is a simplified table showing tabulated data structures as may be used to reference certain characteristics of typical IBIS formats.

FIG. 4 is a simplified flow chart showing a method of serving IBIS data responsive to a given user request in accordance with an embodiment of the present invention.

FIG. 5 is a simplified schematic diagram showing a buffer useful for assisting discussion of known interface characterization procedures, as may be further useful for assisting an understanding of certain embodiments of the present invention.

### DESCRIPTION

In the following description, specific details may be set forth to provide an understanding of exemplary embodiments of the present invention. It will be understood, however, that alternative embodiments may comprise various sub-combinations of the disclosed examples.

Readily established circuits or procedures for the exemplary embodiments may be disclosed in a simplified form. For example, the system may be represented by simplified block diagrams and/or description so as to avoid obscuring its understanding with unnecessary excess detail. Likewise, to aid a clear and more precise disclosure of given embodiments of the present invention, description of known computer systems and communication methods—e.g., bus networks, controller interconnections, memory mappings and/or configurations, memory access modules, read/write protocols, data header structures of known internet protocols, and other similarly known types of data processing systems and exchange procedures—may be simplified where artisans of ordinary skill in this particular art may readily understand their structures and operations by way of the present disclosure.

As use herein, “IBIS” may be understood to reference Input/Output (I/O) Buffer Information Specification standards, such as that of the EIA-656 standard of the known Electronic Design Automation industry. Such standard may typically be known for characterizing various components or circuits (classically, I/O types of buffer circuits) with known “characteristic curves” representative of their various voltage-current performance characteristics and/or their voltage/current-versus-time waveform performance characteristics for a given circuit. The IBIS data generally may be derived by direct measurements from an actual circuit or by way of simulation of a predetermined model for the circuit.

Although, a few different exemplary types of characteristic curves typical to the IBIS standard are referenced herein; it will be understood, however, to those now skilled in the art that the systems and methods presently disclosed for particular embodiments of the invention may similarly be applicable relative to not only the exemplary types of IBIS curves referenced herein, but may also be applicable relative to other types of IBIS curves as now known to the IBIS standard(s) or as may yet be devised or adopted into the IBIS standard(s).

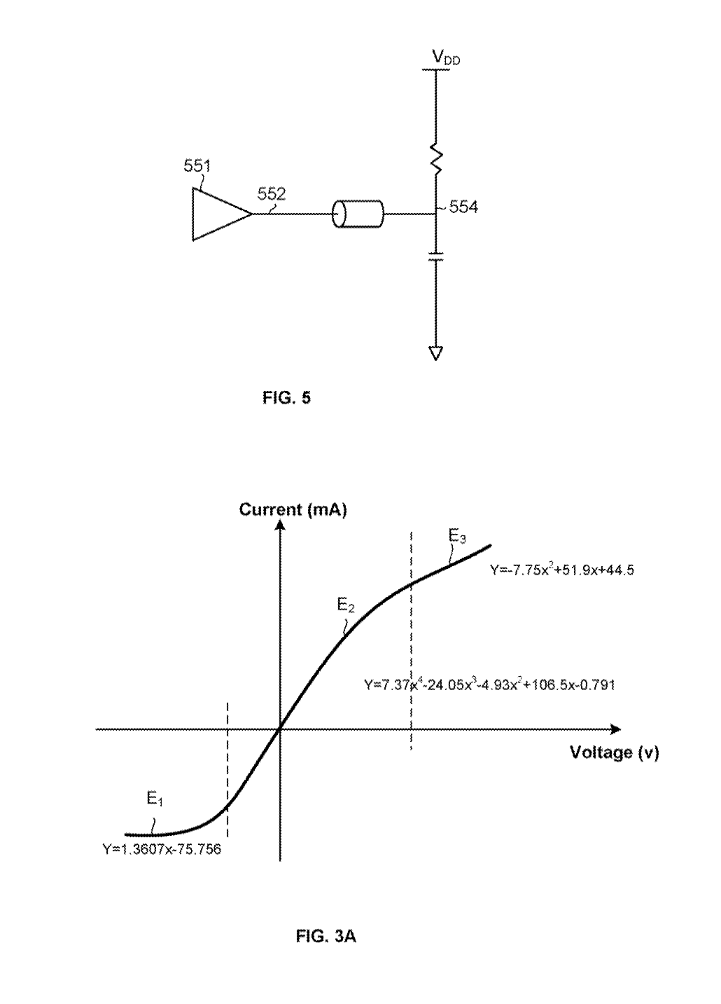

Referencing FIGS. 3A and 3B, the IBIS data for a pull-up type of characteristic curve may be characterized for a given device. Again, it may be understood that an alternative curve could be selected such as for the pull-down, power-clamp, ground-clamp, rising and/or falling waveform characteristics. The buffer associated with this example may be understood to be specified with an exemplary supply level of 1.5 volts. The particular curve may further be understood to represent one of various columns of a typical IBIS tabular format, such as one of typical, minimum or max columns in the table of FIG. 3B. It this example, the column may he associated with merely one fabrication process tolerance for the buffer, as may be associated with, e.g., a typical (typ) speed of operation. Such string of data may be tabulated in the IBIS data format for particular current-versus-voltage data points. For example, the tabulation of data may begin with measurement data point of voltage −1.5 V and current −77.8 mA. As further represented in the table, in the typical column, this tabulation continues for the incremental, sequential measurement steps along the voltage axis of −1.4V, −1.3V . . . , up and through 0.0V and further up to . . . 2.8V, 2.9V and 3.0V. As may be noted in this particular example, the respective current levels for these noted measurement points correspond to −77.66 mA, −77.52 ma . . . 0.325 ma . . . 128.89 ma, 129.79 ma and 130.49 ma respectively.

In accordance with a particular embodiment, further referencing FIG. 3A, this IBIS curve for the pull-up characteristics of the buffer (e.g., of presumed 1.5 volt supply condition and of fabrication process tolerances for typical conditions), may be divided into a plurality of curve elements—e.g., three separate elements E₁, E₂, E₃. Further referencing FIG. 3A, the three different elements E₁, E₂, E₃ by which to partition the IBIS curve may be further identified with respective breakpoints. In FIG. 3A, these breakpoints have be indicated by the phantom lines extending vertically at two different locations along the horizontal voltage axis.

Further referencing FIG. 3A, a polynomial may be determined for the first element E₁ of the partitioned curve, which corresponds to the portion left of the left most breakpoint. In this particular case, the first element may be determined as being representative of a first order polynomial (linear) expression of two coefficients, such as:

E₁→y=1.36x−75.8.

Likewise the second and third elements of the partitioned curve may be referenced in the example of FIG. 3A as between the two breakpoints and to the right of the right most breakpoint respectively. The polynomial expressions therefore may be determined for this example with fourth and second orders respectively and with their associated coefficients as follows:

E2→y=7.37x⁴−24.1x³−4.93x²+106x−0.792, and

E3→y=−7.75x²+51.9x+44.5.

Information of these polynomials—e.g., number of elements for the partitioning, their breakpoints, the order and associated coefficients for their polynomials—for fitting the particular “pull-up” IBIS curve may then be stored in a databank for subsequent retrieval. Upon retrieval, IBIS data may then be subsequently re-synthesized from the retrieved polynomial information.

It may be observed that the amount of memory required for storing the polynomial information may be less than which might otherwise be required for storing the typical IBIS data. Not only may the amount of memory required be less for the cataloging of polynomial information relative to that ordinary required for the IBIS data; but additionally, the requirements for information retrieval, delivery and/or management may similarly be eased.

The potential benefits may be further appreciated when considering the typical multiplicity of curves within the IBIS standards—e.g., as may be associated with the minimum and fast speeds, different impedance environments, various levels of supply voltage, given generations for the component, family, particular pin-outs, etc.

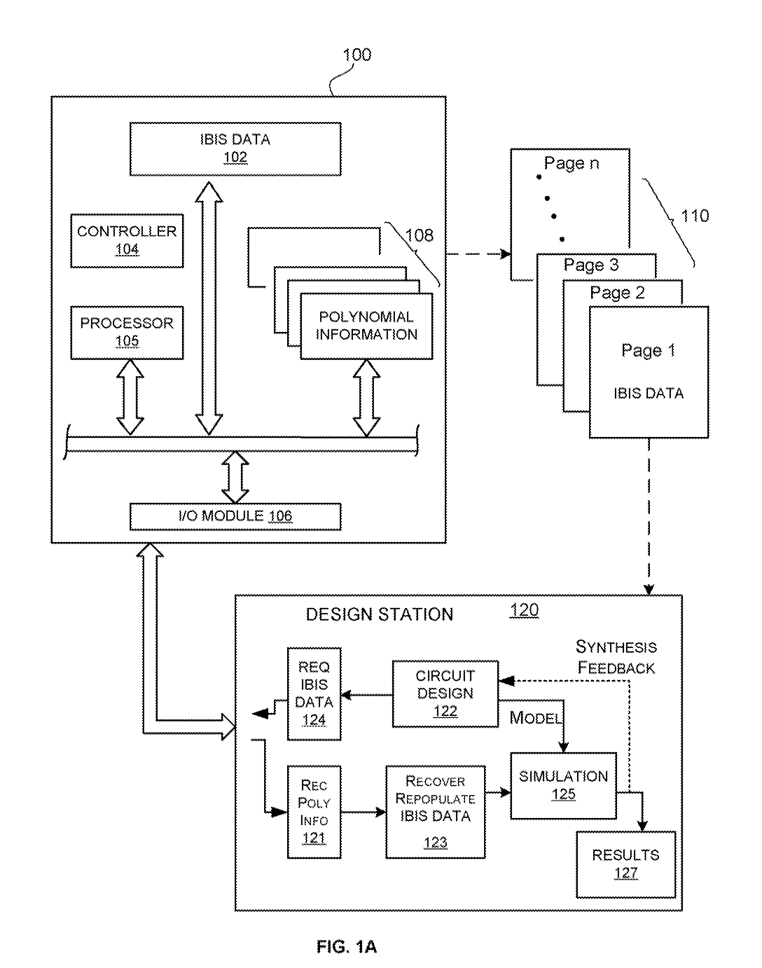

Referencing FIG. 1A, in accordance with an embodiment of the present invention, a computer system 100 for serving IBIS data may comprise a database 108 with information of polynomials determined to be representative of at least a portion of the IBIS data to given components of a component library. A given request may be received from a user, e.g., by way of I/O interface module 106 for requesting the IBIS data to particular components or circuits as may be specified in the user request. Responsive to the request received, a controller 104 may determine the circuit specified by the user request and then retrieve select polynomial information from database 108, which may be associated with at least a portion of the IBIS data for the circuit specified. The polynomial information retrieved may then be forwarded to the user.

By typical procedures, e.g., the voluminous IBIS data of the tabularized structure 110 would have been delivered to the end user by way of lengthy and extensive bandwidth requirements. Certain embodiments of the present invention, in contrast, but not necessarily all embodiments therefore, may enable more consolidated information management and transfer by way of the polynomial information—which may comprise the information regarding the number of elements, breakpoints, and the orders and coefficients for the polynomials.

In a particular embodiment, computer system 100 may obtain IBIS data of a given IBIS library 102. Controller may send at least a portion of the IBIS data as associated with a particular circuit to processor 105. Processor 105 of the computer system may then determine and fit polynomials to the various portion of the IBIS curves. Information regarding the polynomials determined may then be stored in the polynomial databank 108.

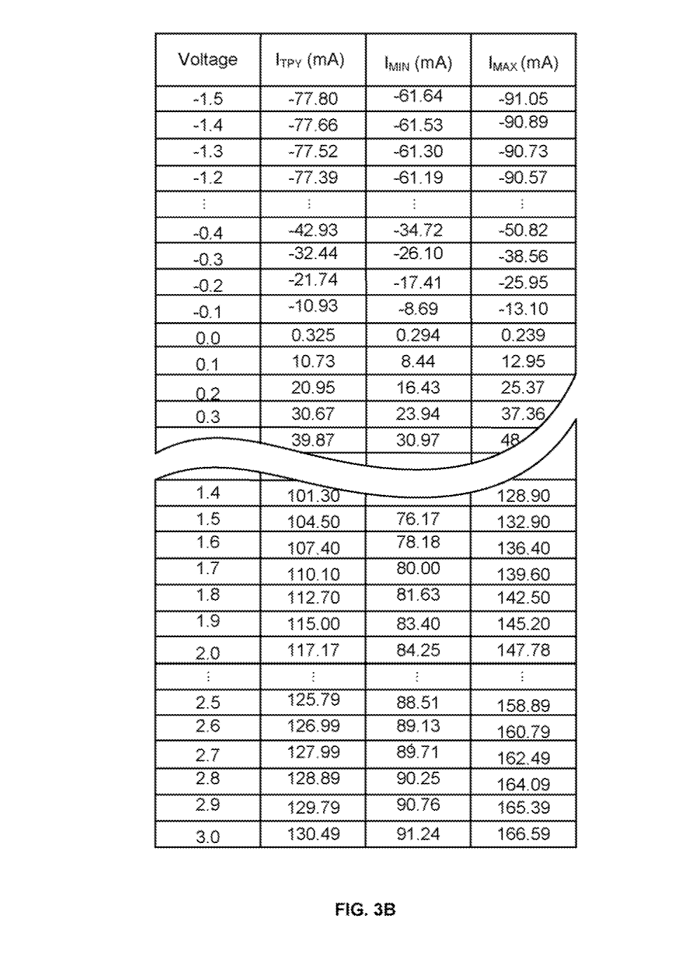

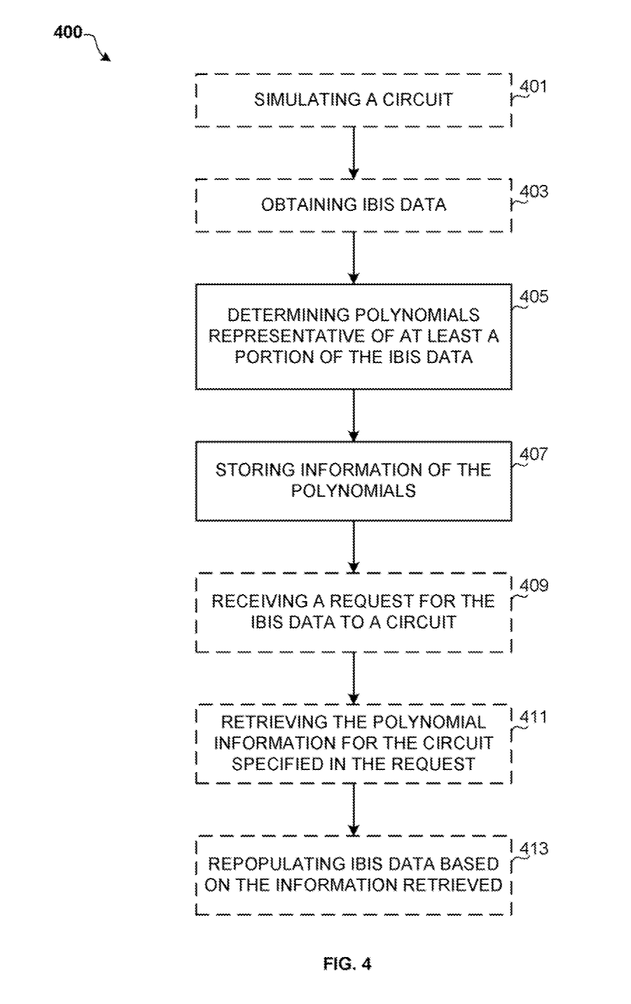

With reference to FIG. 4, in accordance with an embodiment of the present invention, the processor may obtain (block 403 to the flow chart 400) the IBIS data as may be cataloged to a given circuit model. A given curve of the IBIS data may then be processed by available curve fitting algorithms to determine (block 405 of flow chart 400) the polynomial(s) for representing at least a portion of the IBIS data. The polynomial information determined to fit the IBIS data may be stored (block 407) into given tiles of a database (such as database 108 of FIG. 1A) with appropriate indexing so as to enable its selective retrieval by way of the identifying information, which may include, e.g., the circuit name together with any other associated condition criteria.

During this process of curve fitting, a given curve of the IBIS data may be divided into a plurality of elements. Polynomials may then be determined for characterizing each of the elements of the plurality. Thus, the number of elements may be identified, together with their associated breakpoints, and order and associated coefficients for their respective polynomials. Based on the fit of these polynomials to the curve, the number of elements, their breakpoints or the orders and associated coefficients to the polynomials may be adjusted if a better fit is desired.

It may be noted that the polynomial extractions may be obtained using known curve fitting algorithms. For example, the processor may use algorithms such as those of the “trend line” charting procedures of available spreadsheet modules. Other known algorithms may include those as referenced in “Numerical Recipes in Fortran” available by way of reference number ISBN 0-521-43064-X, or alternatively those of “Numerical Recipes in C” of book reference number ISBN 0-521-35465-X. See for example the teachings of “3.5 coefficients of the interpolating polynomial,” which may be discerned to outline various methods for determining coefficients from a given set of data.

Further referencing FIG. 4 relative to FIG. 1A, in accordance with a further embodiment of the present invention, the system 100 for assisting delivery of IBIS data may accordingly receive (block 409 of flow chart 400) a request for the IBIS data to a given circuit. The controller 104 may be responsive to determining the presence, e.g., at I/O module 106, of such request for the specified circuit so as to then index a database based upon the circuit specified. In this particular embodiment, the polynomial information associated with the particular circuit specified may be retrieved (block 411) from the database and forwarded to the user—e.g., such as by way of I/O module 106.

At a receiving end, such as a Electrical Design Automation user station 120 further referencing FIG. 1A and FIG. 4, a predefined macro may be executed in a processor module 121 to process the polynomial information that was delivered to the user. The polynomials determined therefrom may then be used to recalculate and populate (block 413 of the flow chart 400 of FIG. 4) IBIS data for the specified circuit. IBIS management module 123 of the EDA design station 120 may then supply the IBIS data as known for use as needed in high level signal analysis procedures that may incorporate the specified circuit.

A simulation module 125 of the EDA design station may analyze a given system design 122 that may incorporate the user specified circuit. Results 127 from the simulation may then be represented by way of known user interface means. These results may cause the designer to modify the system design 122. This in turn may result in the user specifying another component of a particular vendor catalog Thus, a new user request 124 may be generated and sent to an IBIS data server as part of another design iteration.

In accordance with an alternative embodiment of the present invention, the computer system 100 (further referencing FIG. 1A) for serving the IBIS data may include database 108 of the polynomial information representative of IBIS data. Responsive to receipt of a user request for the IBIS data to a specified circuit, the polynomial information may be selectively retrieved from the database 108 and delivered to processor 105. The processor 105 may then re-synthesize from the polynomials the IBIS data of the standard tabular form 110. The IBIS data re-synthesized may then be delivered to the user, such as the EDA station 120, for known uses such as in high level signal integrity analysis. Thus, the database 108 for retention of the polynomial information within the server system 100 may realized with less memory than that which might otherwise be required for storage of IBIS data of the more customary tabular formats.

In another embodiment, the on-board database 102 of the computer system 100 may be preconfigured with the IBIS data for given circuit or components, such as those of a given vendor library. This IBIS data may be retrieved and processed by known curve fitting algorithms for reducing the amount of data that is to be delivered to the user responsive to a request for the IBIS data to a given circuit. Accordingly, processor 105 may extract the polynomial information to various curves of the IBIS data. This polynomial information may then be delivered to the user, such as to the EDA station 120. Again, a macro may be sent with the polynomial information to enable reconstruction of the polynomials and re-synthesis of the IBIS data for the specified circuit.

As thus described, the IBIS data may have been predetermined from standard sources. In accordance with a further embodiment, the processor 105 may be further operable to determine the IBIS data to a specified circuit by way of known methods of analysis (block 401 of FIG. 4) of a predefined model for the specified circuit. For example, a circuit model of predefined netlist may be retrieved from a given library 162 (referencing FIG. 1B). A circuit analysis module 164, such as a SPICE analysis module, may process (401 of FIG. 4) the circuit model for analysis and generation of IBIS data 102 for the specified circuit. This IBIS data may then be used by the IBIS data server system 100 as referenced previously relative to FIG. 1A.

In a further embodiment, the simulation (401 of FIG. 4) of the specified circuit may be performed for the circuit under predefined conditions. For example, the condition may include a predefined parameter such as the impedance to be presented to the input and/or output of the modeled circuit. Such impedance could be characterized with levels as low as 20 ohms or 25 ohms . . . or up to levels as high as 100 ohms or more. More typically, particularly in analog environments, the impedance may be specified generally between 40 to 75 ohms.

Another condition that may identified for the circuit may include a given fabrication tolerance as may be associated with processes of the vender during production of the cataloged circuit or component. For example, a given process corner of the vender's fabrication flow may produce slower or faster operational speed effects for the specified circuit or component.

Additionally, another circuit condition that can be defined for the circuit condition may include the level of the supply voltage. Accordingly, the SPICE simulator tool may need to analyze the modeled circuit over each of the various conditions. Therefore, the variety of different curves for the IBIS data may be obtained for the specified circuit over each of the different circuit conditions specified.

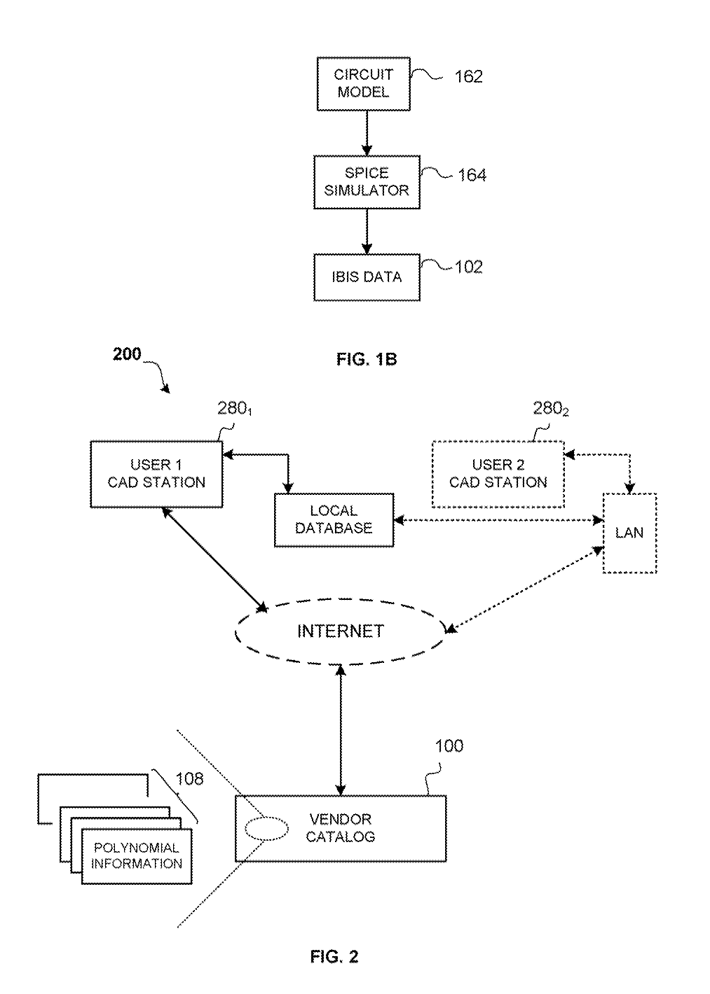

Referencing FIG. 2, in may be understood that IBIS data server station 100 such as of the embodiments described above relative to FIG. 1A, may be utilized by a vendor or manufacture for serving IBIS data to various user stations 280. The delivery of the data to these user stations may be performed by way of known internet protocol. In the internet network 200, a user request may be received by server station 100. Responsive to the user request for the IBIS data to a specified circuit, the server station may retrieve a select file from a database 108. The selection may be based upon the circuit specified by the user request. From the select file retrieved, the polynomial information may be obtained for characterizing at least a portion of the IBIS data to the specified circuit. This polynomial information determined may then be forwarded to the user. At the user station, such as that of user CAD station 280₁ or 280₂, the IBIS data may be re-synthesized for repopulation in the standardized formats for subsequent use via known high level signal integrity types of analysis.

In some various alternative embodiments therefore, further referencing FIG. 2, the IBIS data may be repopulated in a local LAN station or another locally shared database for subsequent standardized IBIS retrieval by various user stations connected thereto. Again, it may be understood that predefined macros may be utilized to enable the repopulation of the IBIS data from the polynomial information.

While certain exemplary features of the embodiments of the invention have been illustrated and described above, if may be understood that various modifications, substitutions, changes and equivalents may now occur to those skilled in the art. It is, therefore, to be understood that the appended claims are intended to cover all such embodiments and changes as fall within the spirit of the invention.

What is claimed is:

1. A method of serving IBIS data, comprising:
specifying a circuit for signal integrity simulation;
obtaining IBIS data for the circuit specified;
determining at least one polynomial for characterizing at least a portion of the IBIS data;
generating a retrievable file with information of the polynomial determined; and
storing the retrievable file in a database to be capable of selective retrieval by way of a request for the IBIS data of the circuit specified.

2. The method of claim 1, in which the obtaining the IBIS data comprises:
analyzing a predefined model of the circuit specified; and
generating at least a portion of the IBIS data relative to at least one of an input interface or an output interface for the circuit specified based on results from the analysis.

3. The method of claim 2, in which
the specifying the circuit further comprises designating for the predefined model for the circuit specified at least one of the following:
an impedance environment for the at least one of the input interface or the output interface,
a speed condition of the group consisting of the group of slow, typical and fast, and
a supply voltage;
the analysis incorporates at least one characteristic curve of the group consisting of a pull-up, a pull-down, ground-clamp, power-clamp, rising-waveform and falling-waveform type of characteristic curve from which to generate at least part of the IBIS data; and
the generating the retrievable tile further comprises indexing the retrievable file based on at least one identifier of the group consisting of circuit name, impedance, speed, supply voltage and type of characteristic curve for the circuit specified.

4. The method of claim 2, in which the predefined model for the circuit specified includes a dynamic element operable in part to influence electrical properties of the at least one of the input interface or the output interface; and
the analysis of the modeled circuit exercises a variable range of the dynamic element.

5. The method of claim 4, in which the analysis of the predefined model comprises performing a SPICE simulation of the predefined model of the circuit specified from which to generate at least a portion of the IBIS data relative to the at least one of the input interface or the output interface.

6. The method of claim 2, in which the determining at least one polynomial comprises:
selecting a particular curve of the IBIS data;
partitioning the curve selected into a plurality of elements; and
determining a polynomial for each of the plurality of elements.

7. The method of claim 6, in which the partitioning and the determining comprise:
defining a number of elements and their associated break-points by which to partition the curve;
defining an order and associated coefficients for each of the polynomials of the plurality;
determining a fit of the polynomials defined relative to the curve; and
dependent upon the fit determined, adjusting at least one of the number of elements, the beak-points for the respective elements, and the order and associated coefficients for the polynomials.

8. The method of claim 7, in which the information of the polynomials determined incorporates discernable information of at least one of the number of elements, their break-points, and the order and associated coefficients defined therefor.

9. The method of claim 8, further comprising;
receiving from a user a request for the IBIS data to a given circuit;
responsive to the request, indexing the database for a select file based upon the circuit specified by the user request and retrieving the information of the polynomials determined therefor; and
sending to the user the information of the polynomial(s) retrieved.

10. The method of claim 9, further comprising:
sending an executable macro to the user, the executable macro predefined to be operable when executed by a user work-station to:
parse the file for at least one of the particular curve, the number of elements, the break-points for the respective ones of the number of elements, and the order and the associated coefficients for polynomial(s) to be associated with the respective ones of the number of elements; and
calculate and repopulate IBIS data for the given circuit based on the polynomial information obtained from the file.

11. A system for assisting delivery of IBIS data, comprising:
a database having a plurality of selectively retrievable files, at least one select file of the plurality of files to store information for at least one polynomial determined to characterize at least a portion of the IBIS data to a given circuit;
an I/O interlace module to receive a request for IBIS data to a specified circuit; and
a controller operatively configured to be responsive to such type of request at the I/O interlace module to:
index, dependent upon the circuit specified in the request, the database for a select file of the plurality,
retrieve the information for the at least one polynomial associated with the at least a portion of the IBIS data for the given circuit stored in the select file, and
send the information retrieved for the at least one polynomial to the I/O interface for output.

12. The system of claim 11, further comprising a processor operable to determine polynomials for characterizing at least a portion of the IBIS data for a modeled circuit;
wherein the controller is further operable to store information of the polynomials determined in a selectively retrievable file of the database to be available for selective retrieval by way of request for the modeled circuit.

13. The system of claim 12, further comprising:
a circuit library configured with a predefined netlist for modeling the circuit; and
a circuit simulator operable to enable analysis of the predefined netlist of the modeled circuit for generating the IBIS data relative to at least one of an input interface or an output interface for the modeled circuit.

14. The system of claim 13, in which the circuit simulator is operable to simulate the circuit relative to the at least one of the input interface or the output interface over at least one characteristic curve type of analysis of the group consisting of a pull-up, a pull-down, ground-clamp, power-clamp, rising-waveform and falling-waveform type.

15. The system of claim 14, in which the circuit simulator is further operable to simulate the circuit over at least one circuit condition of the group consisting of:
a specified impedance environment,
a given fabrication process tolerance of the group consisting of slow, typical and fast,
a specified operational speed, and
a level of supply voltage.

16. The system of claim 14, in which the controller is further operable when storing the information of the polynomials to index the file for enabling its selective retrieval from the database by way of the at least one identifier of the group consisting of the characteristic curve types and the at least one of the circuit conditions.

17. The system of claim 16, in which the processor is further operable, during at least a part of determining the polynomials, to:
select a given curve of the at least one of the characteristic curves,
partition the given curve into a plurality of elements, and
determine polynomial(s) and the respective order and coefficients for the polynomials determined for each element of the plurality of elements.

18. In a computer system for serving IBIS data for various circuit models, a method comprising:
receiving a user request for the IBIS data to a specified circuit;
retrieving a select file from a database, the selection based upon the circuit specified in the user request;
obtaining from the select file retrieved, polynomial information that characterizes at least a portion of the IBIS data for the specified circuit; and
forwarding to the user specified by the request, text data based on the polynomial information determined from the select file to characterize the at least portion of the IBIS data.

19. The method of claim 18, further comprising:
simulating performance of the specified circuit by analysis of a predefined model therefore, the predefined model defined in part by at least one circuit condition of the group consisting of:
an impedance presented to the at least one of the input interface or the output interface,
a fabrication process tolerance thereof related to one of the group consisting of slow, typical and fast,
a specified operational speed, and
a level of a supply voltage;
generating from the simulation of the predefined model at least a portion of the IBIS data for the specified circuit relative to at least one of an input interface or output interface therefore, wherein the simulation and generation of the IBIS data incorporate at least one characteristic type curve of the group consisting of pull-up, pull-down, ground-clamp, power clamp, rising-waveform and falling waveform types; and
storing in the database for the select file, information of at least one polynomial associated with characterizing at least a portion of the characteristic type curves for the specified circuit together with an identifiers) of the particular characteristic type curve and the at least one circuit condition, wherein the selective retrieval from the database is further based upon specified characteristic curve and circuit condition identifying information of the user request.

20. The method of claim 18, further comprising forwarding a macro to the user operable when executed to calculate and repopulate the IBIS data from the polynomial information forwarded for the specified circuit for operability in an IBIS analysis module of the user.
